(19) United States
(12) Patent Application Publication
(10) Pub. No.: US 2023/0354852 A1
(43) Pub. Date: Nov. 9, 2023

(54) DIE, PLANT AND PROCESS FOR PRODUCING EDIBLE SNACKS FOR ANIMALS

(71) Applicant: PAVAN S.p.A., Galliera Veneta (IT)

(72) Inventor: Vanni ANTONELLO, Galliera Veneta (IT)

(21) Appl. No.: 18/040,252

(22) PCT Filed: Jul. 29, 2021
(86) PCT No.: PCT/IB2021/056926

§ 371 Date: Feb. 1, 2023

(30) Foreign Application Priority Data
Aug. 7, 2020 (IT) 102020000019684

(51) Int. Cl. A23K 40/25; A23K 40/20

(52) U.S. Cl. CPC A23K 40/25; A23K 40/20

(57) ABSTRACT

A die for edible products for animals. The die may include at least one through drawing cavity having a prevalent development along a longitudinal direction. The through cavity may include at least one first group of grooves and a second group of grooves having a development substantially parallel to the longitudinal direction. In a transversal section with respect to the longitudinal direction, each groove of the first group has a greater depth with respect to the depth of each groove of the second group and each groove of the first group alternates with a groove of the second group.

### TECHNICAL FIELD

The present invention relates to a die, a plant and a process for producing edible snacks for animals.

### BACKGROUND

Food products for animals are known, which conciliate the sustenance function with other functions. Among these, food products for animals are known, for example for dogs or cats, which have the purpose of dealing with for dental hygiene.

In particular, a solution of the known type envisages the use of recipes that contain particles adapted to remove dirt from teeth (e.g. bentonite), whereas another known solution envisages the use of pointed shapes able to enter between one tooth and another for cleaning. There are also solutions that use the two aforesaid characteristics in combination.

The solutions of the known type described above have the drawback that the mechanical cleaning of the teeth is left to chance, i.e. it is not guaranteed in a repeatable way.

From document US 2006/188632 A1 and WO 2019/071336 A1 there are known pet treats obtained by extrusion. These pet treats have grooves and protrusions that can penetrate in the pet's teeth.

### SUMMARY

A production process of edible snacks for animals may include dosing at least a first amount of solid ingredients and/or a second amount of liquid ingredients according to a predetermined recipe and kneading the dosed ingredients so as to obtain a dough. The process may also include extruding and cooking the dough and making the extruded and cooked dough pass into a die, the die receiving the cooked dough at the inlet of the through cavity and providing elongated products at the outlet of the through cavity. The process may also include cutting the elongated products into a plurality of edible snacks and cooling the snacks.

### BRIEF DESCRIPTION OF DRAWINGS

Further characteristics and advantages of the present invention will become clearer from the indicative, and therefore non-limiting, description of a non-exclusive embodiment of a die, a plant and a process for producing edible snacks for animals, as illustrated in the attached drawings, in which:

FIG. 1 illustrates a sectional view of a die, according to the present invention;

FIG. 2 shows a view from one side (inlet) of an embodiment of the die of FIG. 1;

FIG. 3 shows a view from the opposite side (outlet) of the die of FIG. 1;

FIG. 4 shows a detail (inlet section of the through cavity) of the die of FIG. 1;

FIG. 5 shows a detail (outlet section of the through cavity) of the die of FIG. 2;

FIG. 6 shows a view from one side (inlet) of an alternative embodiment of the die of FIG. 1;

FIG. 7 shows a view from the opposite side (outlet) of the alternative embodiment of the die of FIG. 1;

FIG. 8 shows a detail (inlet section of the through cavity) of the die of FIG. 6;

FIG. 9 shows a detail (outlet section of the through cavity) of the die of FIG. 7;

FIG. 10 shows two triangles from the intersection of which the section of the through cavity of the embodiment of the die of FIG. 1 is obtained;

FIG. 11 shows two three-pointed stars from the intersection of which the section of the through cavity of the embodiment of the die of FIG. 6 is obtained;

FIG. 12 shows a perspective view of an embodiment of an edible snack for animals, obtained through the embodiment of the die of FIG. 1;

FIG. 13 shows a front view of the snack of FIG. 12;

FIG. 14 shows a perspective view of another embodiment the edible snack, obtained through the embodiment of the die of FIG. 6;

FIG. 15 shows a front view of the snack of FIG. 14;

FIG. 16 shows a production plant of edible snacks for animals, according to the present invention, in a front view;

FIG. 17 shows a partially sectioned perspective view of the production plant of FIG. 16; and

FIG. 18 shows a detail (compression screw) of the production plant of FIG. 16.

### DETAILED DESCRIPTION

In this context, the technical task underpinning the present disclosure is that of proposing a die, a plant and a process for producing edible snacks for animals, which obviate the drawbacks of the prior art cited above.

In particular, the object of the present disclosure is to propose a die, a plant and a process for producing edible snacks for animals, able to produce snacks that guarantee the repeatable cleaning of teeth, i.e. not left to chance.

Another object of the present disclosure is to provide a production plant of edible snacks for animals, having a simplified structure with respect to the solutions of the prior art.

The technical task specified and the objects specified are substantially achieved by a die, comprising at least one through drawing cavity having a prevalent development along a longitudinal direction. Originally, the through cavity comprises at least a first group of grooves and a second group of grooves having a development substantially parallel to the longitudinal direction. In a transversal section with respect to the longitudinal direction, each groove of the first group has a greater depth than the depth of each groove of the second group. Each groove of the first group alternates with a groove of the second group.

Preferably, the grooves of the first group have the same depth.

Preferably, the grooves of the second group have the same depth.

According to one embodiment, the grooves of the first group and the grooves of the second group are respectively three and are defined by the intersection of a first geometric figure and a second geometric figure with three tips rotated with respect to one another. The first figure is similar and has larger dimensions than the second figure.

According to one embodiment, the first geometric figure and the second geometric figure are rotated substantially by 180° with respect to one another.

According to one embodiment, the first geometric figure and the second geometric figure are triangles.

According to one embodiment, the first geometric figure and the second geometric figure are three-pointed stars.

The defined technical task and the specified objects are substantially achieved by a production plant of edible snacks for animals, comprising:
a dosing unit of ingredients of the solid and/or liquid type;
a kneading unit of the ingredients so as to obtain a dough;
an extrusion and cooking unit of the dough, which comprises a die according to any one of the preceding claims, the die receiving the cooked dough at the inlet of the through cavity and providing elongated products at the outlet of the through cavity;
a cutting unit operatively active on the elongated products coming from the die so as to cut them transversely and to obtain a plurality of snacks.

Preferably, the production plant further comprises a cooling unit for cooling the snacks, placed downstream of the cutting unit.

Preferably, the cutting unit comprises a cutting station in which the products to be cut are arranged and a double-edged guillotine arranged at the cutting station and mobile in alternative motion between a first position above the cutting station and a second position below the cutting station.

Preferably, the extrusion and cooking unit comprises one or more extrusion screws developing along an advancing direction of the dough. The production plant further comprises a compression screw for the dough arranged upstream of the extrusion and cooking unit having a development inclined with respect to the advancing direction of the dough.

Preferably, the extrusion and cooking unit comprises a gas removal station for removing gas from the dough arranged upstream of the die.

The defined technical task and the specified objects are substantially achieved by a production process of edible snacks for animals, comprising the steps of:
dosing at least a first amount of solid ingredients and/or a second amount of liquid ingredients according to a predetermined recipe;
kneading the dosed ingredients so as to obtain a dough;
extruding and cooking the dough;
making the extruded and cooked dough pass into a die, the die receiving the cooked dough at the inlet of the through cavity and providing elongated products at the outlet of the through cavity;
cutting the elongated products into a plurality of edible snacks;
cooling the snacks.

Preferably, the production process comprises a step of compressing the dough before the step of extruding and cooking the dough.

With reference to the figures, reference numeral 1 indicates a die for edible snacks for animals. The term “die” or “die plate” or “drawing machine” mean herein a unit comprising a perforated matrix through which a product to be narrowed and formed is passed, by forcing.

The die 1 comprises at least one through drawing cavity 2 having a prevalent development along a longitudinal direction 3.

Originally, the through cavity 2 comprises at least one first group of grooves 4 and a second group of grooves 5 having a substantially parallel development to the longitudinal direction 3. In particular, with reference to a transversal section with respect to the longitudinal direction 3, each groove 4 of the first group has a greater depth than the depth of each groove 5 of the second group. Each groove 4 of the first group alternates with a groove 5 of the second group.

The depth of the groove 4, 5 means the length of the groove 4, 5 considered in the cross section.

Preferably, the grooves 4 of the first group have the same depth.

Preferably, the grooves 5 of the second group have the same depth which, as mentioned above, is different from the depth of the grooves 4 of the first group.

According to one embodiment, the grooves 4, 5 of each group are substantially V-shaped. The vertex of the V-shaped groove 4, 5 may be pointed or rounded.

According to another embodiment, the grooves 4, 5 of each group are substantially U-shaped.

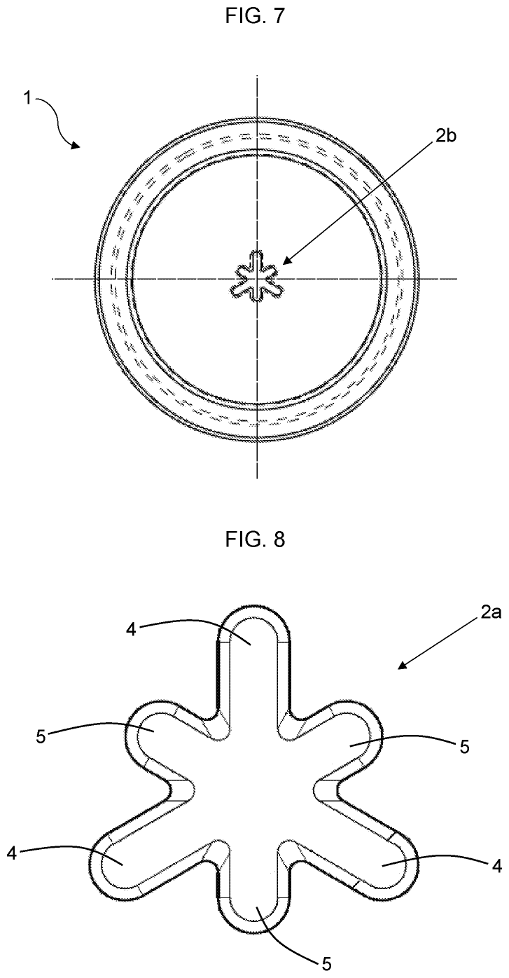

According to one embodiment, the grooves 4 of the first group and the grooves 5 of the second group are respectively three. They are defined by the intersection of a first geometric FIG. 6, 8 and a second geometric FIG. 7, 9 with three tips, which are rotated with respect to one another.

The first geometric FIG. 6, 8 and the second geometric FIG. 7, 9 are similar.

In general, the expression “similar” or “geometrically similar” means herein that there is an isometry that enables the second figure to be arranged so that it is a homothetic image of the first. More specifically, two polygons are said to be “geometrically similar” if the corresponding angles are substantially equal and the pairs of sides that comprise corresponding angles are proportional.

Specifically, the first geometric FIG. 6, 8 has larger dimensions than the second geometric FIG. 7, 9.

According to one aspect of the disclosure, the first geometric FIG. 6, 8 and the second geometric FIG. 7, 9 are rotated substantially by 180° with respect to one another.

According to one embodiment, shown in FIG. 10, the first geometric FIG. 6 and the second geometric FIG. 7 are similar triangles, rotated with respect to one another. The second triangle 7 has smaller dimensions than the first triangle 6.

Preferably, the two triangles 6, 7 are equilateral.

Preferably, the two triangles 6, 7 are rotated substantially by 180° with respect to one another.

In this embodiment, the grooves 4 of the first group are defined by the points of the first triangle 6 and the grooves 5 of the second group are defined by the points of the second triangle 7. A point of a triangle means a portion of the triangle situated in proximity to one of the vertices.

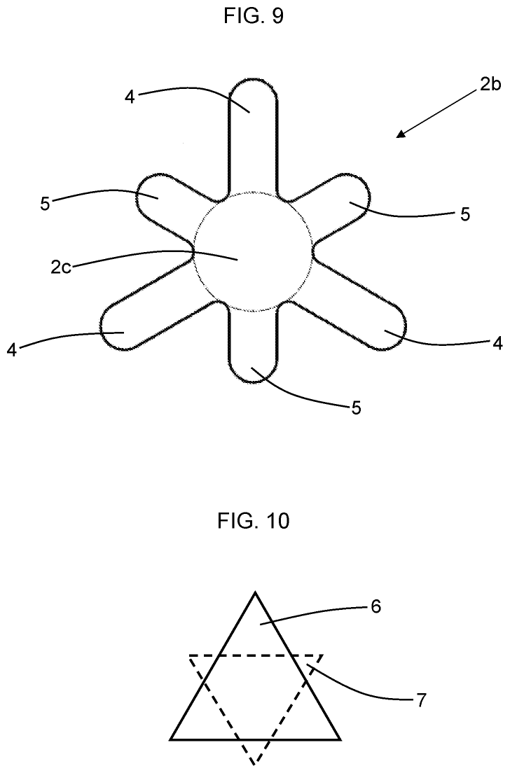

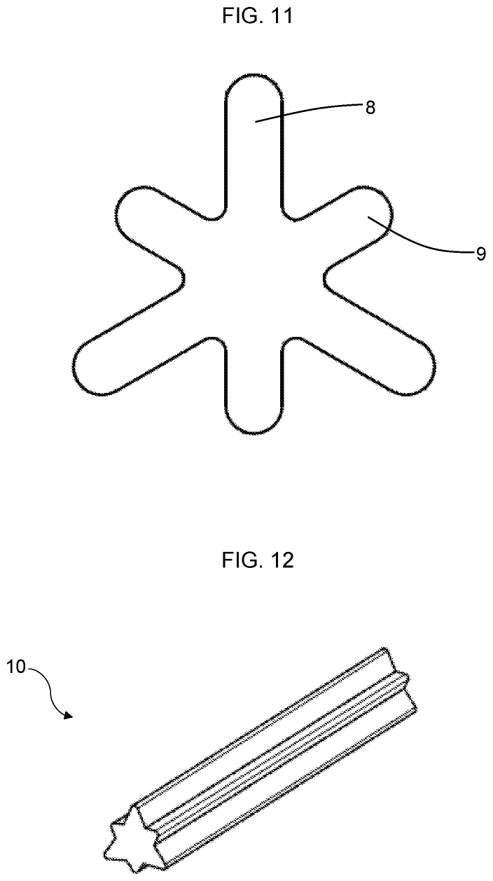

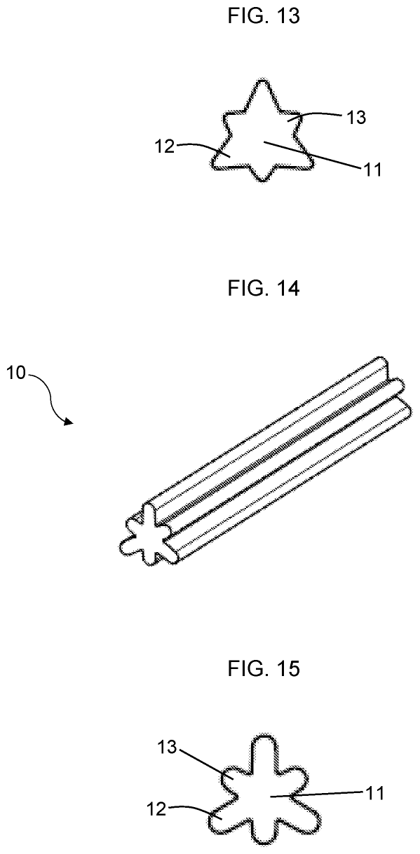

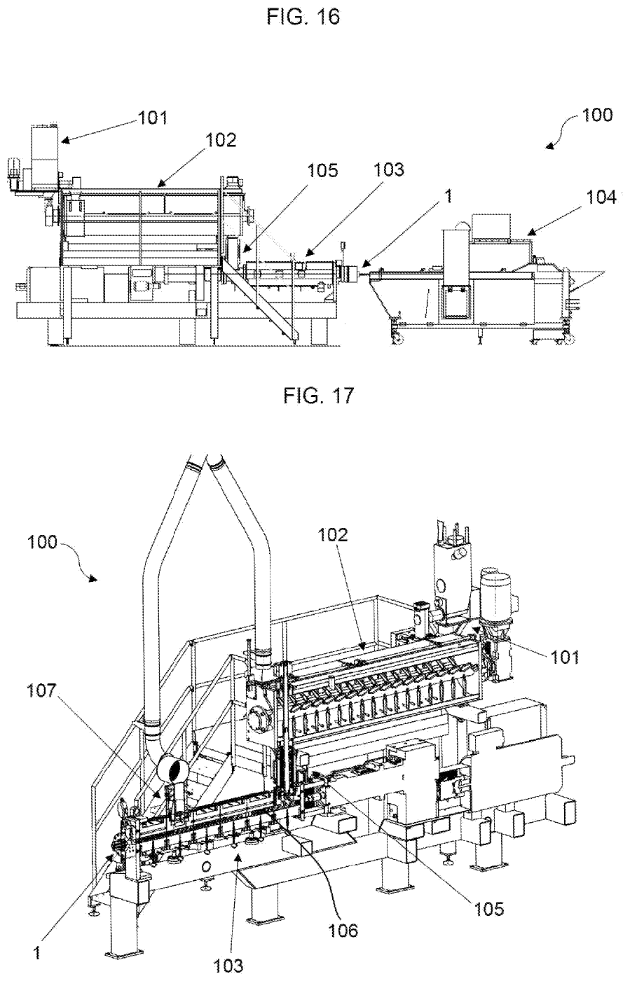

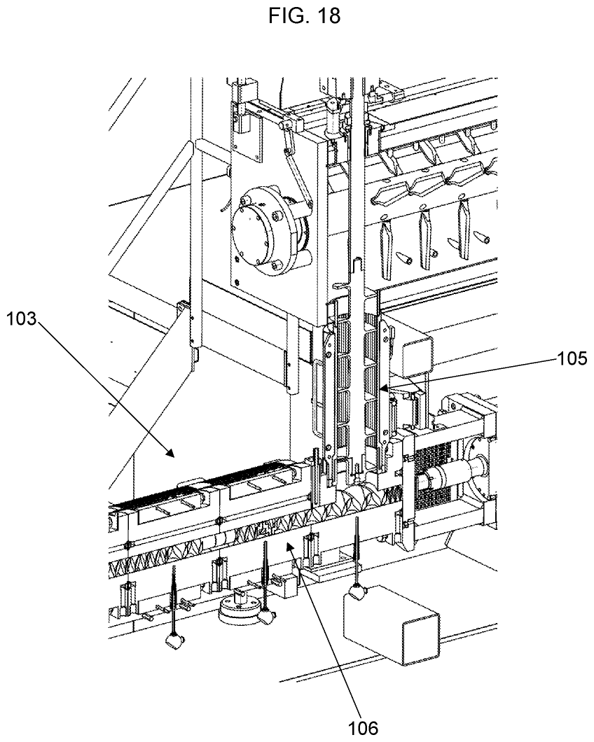

According to one embodiment, illustrated in FIG. 11, the first geometric FIG. 8 and the second geometric FIG. 9 are three-pointed stars.

The first three-pointed star 8 and the second three-pointed star 9 are rotated with respect to one another, preferably by 180°. The second three-pointed star 9 has smaller dimensions with respect to the first star 8.

In this case, the grooves 4 of the first group are defined by the points of the first star 8 and the grooves 5 of the second group are defined by the points of the second star 9.

The points of the stars 8, 9 may be rounded, as illustrated in FIG. 11, or may be pointed (variant not illustrated).

In this embodiment, as can be seen in FIG. 8 or 9, the through cavity 2 in the cross section is comprised of a circular central cavity 2c and by the grooves 4, 5 of the two groups that develop radially starting from the circular central cavity 2c.

According to a further embodiment (not illustrated), the through cavity 2 comprises further groups of grooves, wherein the grooves of each group have a different depth with respect to the grooves of the other groups. Preferably, the grooves of the different groups alternate transversally according to a predefined sequence.

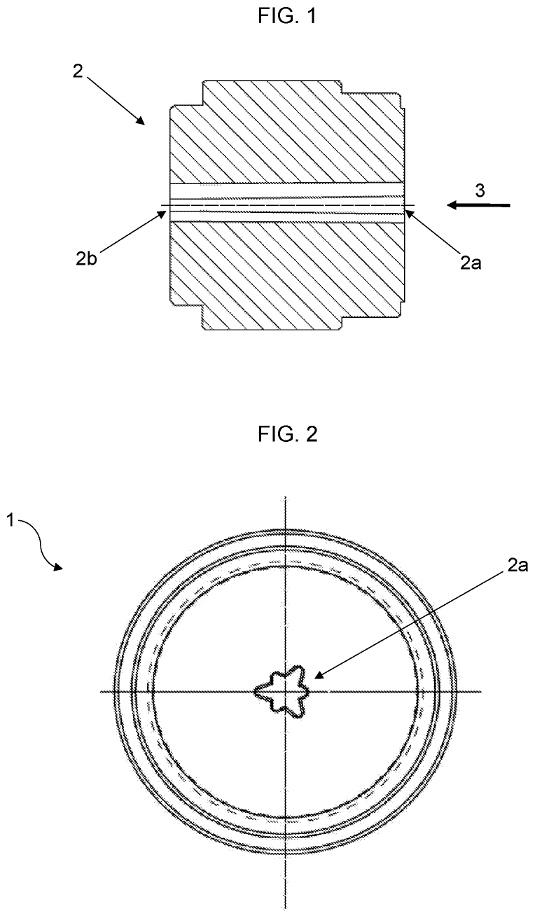

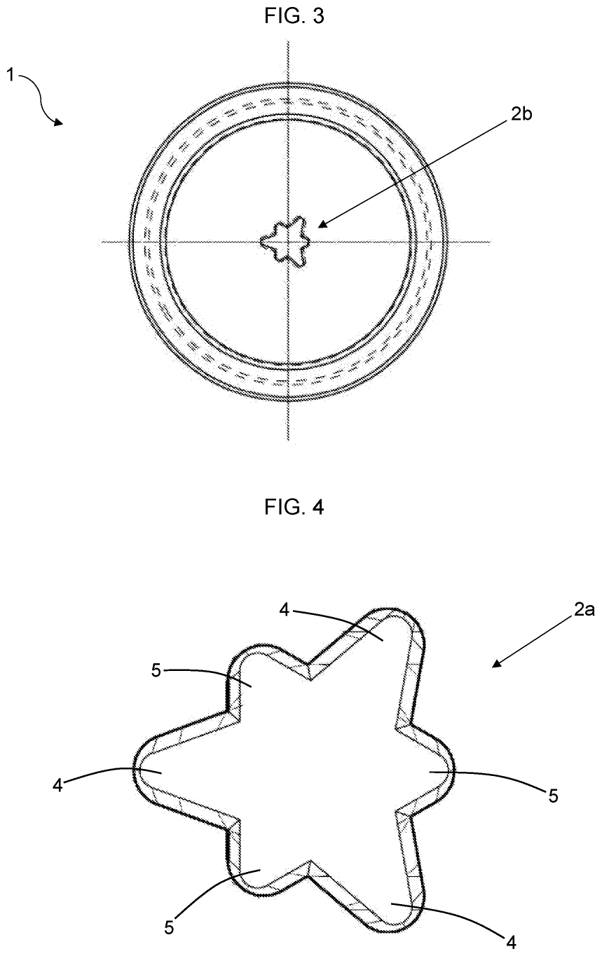

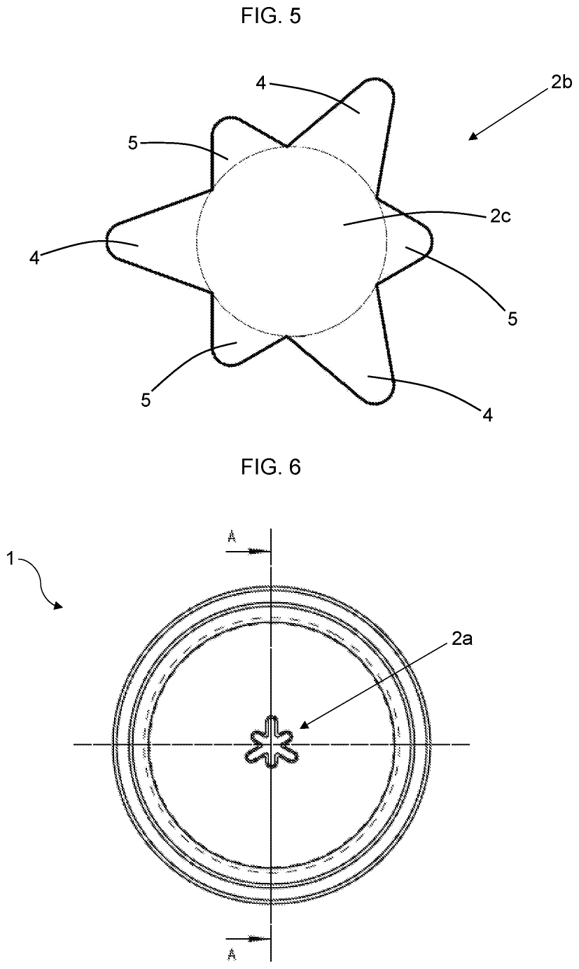

Preferably, as shown in FIGS. 1 to 9, the through cavity 2 has a tapered development along the longitudinal direction 3, i.e. it has a cross section having gradually decreasing dimensions along the advancing direction of the dough. In other words, the dimensions of a cross section of the through cavity 2 in an inlet area (inlet section 2a) of the dough are greater with respect to the dimensions of a cross section in an outlet area of the dough (outlet section 2c).

According to one embodiment (not shown), the die 1 comprises a plurality of through cavities 2.

Such through cavities 2 may all be the same, e.g. with V-shaped grooves or with U-shaped grooves, or partially of one type and partially of the other type just described.

In another variant, one or more of the through cavities 2 may be made according to different embodiments from those described above, e.g. spiral shaped, substantially cylindrical, etc.

The die 1 receives at the inlet a cooked dough and transforms it into an elongated string for each through cavity 2 formed by a central core 11 having a prevalent development in a first direction, from which projections 12, 13 or ribs protrude, which also have a prevalent development along the first direction. The first direction is substantially parallel to the longitudinal development direction 3 of the die 1.

From the elongated string, a plurality of edible snacks 10 is obtained by cross cutting.

In particular, each edible snack 10 comprises at least one group of projections 12 and a second group of projections 13 obtained respectively from the first group of grooves 4 and from the second group of grooves 5 of the die 1.

In other words, the projections 12 of the first group are countershaped with respect to the grooves 4 of the first group, whereas the projections 13 of the second group are countershaped with respect to the grooves 5 of the second group.

According to one embodiment, the snack 10 has projections 12, 13 of ribs with a substantially solid V-shape. The vertex of the V-shaped projection 12, 13 may be pointed or rounded. In this case, the grooves 4, 5 of the through cavity 2 of the die 1 are substantially V-shaped.

According to another embodiment, the projections 12, 13 have a substantially solid U-shape, obtained from the countershaped U-shape of the grooves 4, 5. In other words, the projections 12, 13 have a lobe shape. In the embodiment in which the grooves 4 of the first group and the grooves 5 of the second group are defined by the intersection of a first and a second triangle 6, 7, the projections 12 of the first group are substantially the points of the first triangle 6, whereas the projections 13 of the second group are substantially the points of the second triangle 7.

In the embodiment in which the grooves 4 of the first group and the grooves 5 of the second group are defined by the intersection of a first and a second star 8, 9, the projections 12 of the first group are substantially the points of the first star 8, whereas the projections 13 of the second group are substantially the points of the second star 9.

A production plant of edible snacks for animals, according to the present disclosure, is described below.

The production plant 100 further comprises at least:
a dosing unit 101 of ingredients of the solid and/or liquid type;
a kneading unit 102 of the ingredients so as to obtain a dough;
an extrusion and cooking unit 103 of the dough, which comprises a die 1 according to what is described above.

The die 1 receives the cooked dough at the inlet to the through cavity 2 and supplies elongated products at the outlet from the through cavity 2. In this context, the elongated products are also indicated as “strings”.

Preferably, the production plant 100 comprises a cutting unit 104 operatively active on the elongated products coming from the die 1 so as to cut them transversely and to obtain a plurality of edible snacks 10.

Preferably, the cutting unit 104 comprises a cutting station in which the products to be cut are arranged and a double-edged guillotine arranged at the cutting station and mobile in alternative motion between a first position above the cutting station and a second position below said cutting station. In this way, an elongated product at the outlet from the die 1 is cut alternatively from opposite sides of the cutting station.

Preferably, a cooling unit (not shown) for cooling the snacks 10 is placed downstream of the cutting unit 104. In this way, the elongated products are cut into snacks 10 and subsequently cooled substantially to room temperature.

Preferably, the production plant 100 further comprises a compression screw 105 of the dough placed upstream of the extrusion and cooking unit 103.

The extrusion and cooking unit 103 comprises one or more extrusion screws 106 prevalently developing along an advancing direction. The compression screw 105 has an inclined development with respect to the development direction of the extrusion screw 106, i.e. with respect to the advancing direction.

Preferably, the compression screw 105 has a substantially orthogonal development with respect to the development direction of the extrusion screw 106.

Preferably, the extrusion and cooking unit 103 comprises a gas removal station 107 for removing gas from the dough placed upstream of the die 1. In the sector, the gas removal operation is known by the term “venting”. The venting operation is particularly important as the snack must have a rubbery texture to maintain its efficacy, but at the same time it must be fully digestible for the animal. Without venting, the cooking would instead cause an undesired expansion effect.

A production process of edible snacks for animals, according to the present disclosure, is described below.

The production process comprises the step of dosing at least a first amount of solid ingredients and/or a second amount of liquid ingredients according to a predetermined recipe. The recipes to which reference is made herein are of the known type therefore they will not be described further.

The process comprises the step of kneading the dosed ingredients so as to obtain a dough. The dough is then extruded and cooked.

After that, the process comprises the step of making the extruded and cooked dough pass into a die 1 according to what is described above. The die 1 receives the cooked dough at the inlet to the through cavity 2 and supplies elongated products or strings at the outlet from the through cavity 2.

The process then continues with a step of cutting the elongated products into a plurality of edible snacks 10. Subsequently, the snacks 10 are cooled substantially to a predefined temperature, e.g. to room temperature.

Preferably, the process also comprises a step of compressing the dough before extruding it. Such step is preferably performed in the compression screw 105 introduced above. In this context, we also talk about a forced feeding step.

From the description provided, the characteristics of the die, the plant and the production process of edible snacks for animals are clear.

In particular, the particular shape of the through cavity of the die, with an alternation of grooves of different depths enables edible snacks to be formed which can guarantee the repeatable cleaning of teeth with constancy. In particular, in the embodiment in which the grooves of the first group and the grooves of the second group are respectively three, a snack is obtained with three projections or ribs of the first group, of larger dimensions than three projections of ribs of the second group. Two of the three projections of the first group enable a solid support base to be obtained, whereas the third projection of the first group, opposite the other two, is suitable for penetrating between the animal's teeth. Furthermore, the projections of the second group, having smaller dimensions than those of the first group, meet the tooth already in the snack crushing step and act as a brush on the surface of the tooth.

Furthermore, the fact that the elongated products are cut into snacks and subsequently cooled, enables the dimensions of the cooling unit to be reduced as cooling a plurality of loose items takes up less space than cooling elongated products still to be cut.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present invention have been described in detail, it should be understood that the various changes, substitutions, and alterations could be made hereto without departing from the spirit and scope of the present invention.

1. A die for producing an elongated edible string for animals that is formed by a central core having a prevalent development in a first direction, from which at least one group of projections and a second group of projections protrude, which also have a prevalent development along the first direction, said die comprising:
a through cavity having a prevalent development along a longitudinal direction, wherein the through cavity comprises: a first group of grooves and a second group of grooves having a development substantially parallel to said longitudinal direction, wherein in a transversal section with respect to said longitudinal direction each groove of the first group having a greater depth than a depth of each groove of the second group, and each groove of the first group alternating with a groove of the second group,
wherein the grooves of the first group and the grooves of the second group are respectively three and the grooves are defined by an intersection of a first geometrical figure and a second geometrical figure with three tips and rotated with respect to one another, said first figure being similar to and larger in size than said second figure, the at least one group of projections being countershaped with respect to the grooves of the first group and being obtained from said grooves of the first group, and the second group of projections being countershaped with respect to the grooves of the second group and being obtained from said grooves of the second group.

2. The die according to claim 1, wherein the grooves of the first group have the same depth.

3. The die according to claim 1, wherein the grooves of the second group have the same depth.

4. The die according to claim 1, wherein the first figure and the second figure are rotated substantially of 180° with respect to one another.

5. The die according to claim 1, wherein the first figure and the second figure are triangles.

6. The die according to claim 1, wherein the first figure and the second figure are three-pointed stars.

7. A production plant of edible snacks for animals, comprising:
a dosing unit of ingredients of a solid and/or liquid type;
a kneading unit of the ingredients so as to obtain a dough;
an extrusion and cooking unit of the dough, which comprises a die, wherein said die includes a through cavity having a prevalent development along a longitudinal direction, wherein the through cavity comprises: a first group of grooves and a second group of grooves having a development substantially parallel to said longitudinal direction, wherein in a transversal section with respect to said longitudinal direction each groove of the first group having a greater depth than a depth of each groove of the second group, and each groove of the first group alternating with a groove of the second group, wherein the grooves of the first group are three and the grooves of the second group are three and the grooves of the first group and the grooves of the second group are defined by an intersection of a first geometrical figure with three tips and a second geometrical figure with three tips that are rotated with respect to one another, said first figure being similar to and larger in size than said second figure, said die receiving the cooked dough at an inlet of the through cavity and providing elongated strings at an outlet of said through cavity; and
a cutting unit operatively active on the elongated strings coming from the die so as to cut them transversely and to obtain a plurality of snacks.

8. The production plant according to claim 7, further comprising a cooling unit of the snacks arranged downstream of said cutting unit.

9. The production plant according to claim 7, wherein said cutting unit comprises a cutting station wherein the strings to cut are arranged and a double-edged guillotine arranged at the cutting station and mobile in alternative motion between a first position above said cutting station and a second position below said cutting station.

10. The production plant according to claim 7, wherein said extrusion and cooking unit comprises one or more extrusion screws developing along an advancing direction of the dough, said production plant further comprising a compression screw for the dough arranged upstream said extrusion and cooking unit, said compression screw having a development inclined with respect to said advancing direction of the dough.

11. The production plant according to claim 7, wherein said extrusion and cooking unit comprises a gas removal station from the dough arranged upstream of said die.

12. A method to produce production process of edible snacks for animals comprising:
dosing at least a first amount of solid ingredients and/or a second amount of liquid ingredients according to a predetermined recipe;
kneading the dosed ingredients so as to obtain a dough;
extruding and cooking the dough;
making the extruded and cooked dough pass in a die, wherein said die includes a through cavity having a prevalent development along a longitudinal direction, wherein the through cavity comprises: a first group of grooves and a second group of grooves having a development substantially parallel to said longitudinal direction, wherein in a transversal section with respect to said longitudinal direction each groove of the first group having a greater depth than a depth of each groove of the second group, and each groove of the first group alternating with a groove of the second group, wherein the grooves of the first group are three and the grooves of the second group are three and the grooves of the first group and the grooves of the second group are defined by an intersection of a first geometrical figure with three tips and a second geometrical figure with three tips that are rotated with respect to one another, said first figure being similar to and larger in size than said second figure, said die receiving the cooked dough at an inlet of said through cavity and providing elongated strings at an outlet of said through cavity;
cutting the elongated strings in a plurality of edible snacks; and
cooling the snacks.

13. The method according to claim 12, further comprising compressing the dough before the step of extruding and cooking the dough.

14. The method according to claim 12, wherein the grooves of the first group have the same depth and the grooves of the second group have the same depth.

15. The method according to claim 12, wherein the first figure and the second figure are rotated substantially of 180° with respect to one another.

16. The production plant according to claim 7, wherein the grooves of the first group have the same depth.

17. The production plant according to claim 7, wherein the grooves of the second group have the same depth.

18. The production plant according to claim 7, wherein the first figure and the second figure are rotated substantially of 180° with respect to one another.

19. The production plant according to claim 7, wherein the first figure and the second figure are triangles.

20. The production plant according to claim 7, wherein the first figure and the second figure are three-pointed stars.
